(19) United States
(12) Patent Application Publication
(10) Pub. No.: US 2003/0177087 A1
(43) Pub. Date: Sep. 18, 2003

(54) Transaction surveillance

(76) Inventor: David Lawrence, New York, NY (US)

Correspondence Address: CLIFFORD CHANCE US LLP, 200 PARK AVENUE, NEW YORK, NY, 10166, US

(21) Appl. No.: 10/304,909

(22) Filed: Nov. 26, 2002

Related U.S. Application Data
(60) Provisional application No. 60/333,888, filed on Nov. 28, 2001.

(51) Int. Cl. G06F 17/60

(52) U.S. Cl. 705/38

(57) ABSTRACT

The present invention provides methods and systems that facilitate the prevention of money laundering by monitoring various facets of a financial transaction via automated test routines, and automatically generating an action to address a high risk transaction based upon the results of the monitoring. To implement the invention, a reference of high risk variables can be compiled and data descriptive of a financial transaction can be monitored for one or more indications of high risk variables according to predetermined criteria. Indications of high risk variables can be reported and one or more suggested actions can be generated based upon the report.

### CROSS REFERENCE TO RELATED APPLICATIONS

This application claims priority to U.S. Serial No. 60/333,888 filed Nov. 28, 2001 and entitled “Transaction Surveillance” which is relied upon and incorporated by reference.

### FIELD

This invention relates generally to methods and systems for facilitating the identification, investigation, assessment and management of legal, regulatory, financial and reputational risks (“Risks”). In particular, the present invention relates to computerized systems and methods for banks and non-bank Financial Institutions to comply with “know your customer” requirements by identifying high risk situations and generating a suggested action responsive to a particular set of circumstances.

### BACKGROUND

In addition to other responsibilities, financial institutions have a directive to identify and prevent money laundering. Some estimates indicate that $1,000,000,000 or more is laundered globally every day through financial institutions. Money laundering is now punishable by both criminal and civil penalties, which may be imposed on both the firm and its personnel. The risks associated with money laundering therefore include financial, legal, regulatory and reputational risk manifesting substantial consequences for failure to contain such activities.

Trends increasing the likelihood of money laundering and hence financial, reputational and regulatory Risks can include, for example: a greater presence and prospecting in emerging markets where there are less established relationships and less market transparency than more established markets; worldwide movement of assets; an increased focus of law enforcement agencies; potential employee collusion; an increase in global commerce and associated worldwide transfer of funds; an increased use of e-commerce; or other factors.

Such trends have the potential to reduce a financial institution's ability to rely on current know your customer best practices in avoiding money laundering, and lead to a higher volume of lower value transactions due to the increased accessibility to services provided by a financial institution.

Bank and non-bank financial institutions, including: investment banks; merchant banks; commercial banks; securities firms, including broker dealers securities and commodities trading firms; asset management companies; hedge funds; mutual funds; credit rating funds; securities exchanges and bourses; institutional and individual investors; law firms; accounting firms; auditing firms and other entities; hereinafter collectively referred to as “Financial Institutions,” typically have few resources available to them to assist in the identification of present or potential risks associated with money laundering. Nor is a mechanism available to provide real time assistance to assess a risk factor or otherwise qualitatively manage Risks related to money laundering.

What are needed are methods and systems to accommodate increased transaction volume at Financial Institutions and widespread the input of information associated therewith in order to identify and address high risk situations.

### SUMMARY

Accordingly, the present invention provides methods and systems for managing risk associated with one or more financial transactions, by monitoring data descriptive of the transactions and determining if the transactions may be high risk. If the transaction is determined to be high risk, a suggested action is generated. To implement the invention, a reference of high risk variables can be compiled and data descriptive of a financial transaction can be monitored for one or more indications of high risk variables according to predetermined criteria. Indications of high risk variables can be reported and one or more suggested actions can be generated based upon the report.

Monitoring can include, for example: determining if a data value is within a cluster boundary; determining if a data value representing a transaction frequency is within a threshold delta from a previously existing data set; determining if a data value descriptive of a currency amount is within a threshold delta from a previously existing data set; and identifying a pattern relating to financial transactions and determining exceptions to the pattern.

Other embodiments of the present invention can include a computerized system, executable software, or a data signal implementing the inventive methods of the present invention. The computer server can be accessed via a network access device, such as a computer. Similarly, the data signal can be operative with a computing device, and computer code can be embodied on a computer readable medium.

Various features and embodiments are further described in the following figures, drawings and claims.

### DESCRIPTION OF THE DRAWINGS

FIG. 1 illustrates a block diagram that can embody the present invention.

FIG. 2 illustrates a flow of exemplary steps that can be executed while implementing the present invention.

FIG. 3 illustrates additional exemplary steps that can be executed while implementing some embodiments of the present invention.

FIG. 4 illustrates a variation of exemplary steps that can be executed while implementing some embodiments of the present invention.

FIG. 5 illustrates an exemplary network of computer systems that can embody some implementations of the present invention.

FIG. 6 illustrates a controller that can be included in servers or access devices utilized to implement some embodiments of the present invention.

FIGS. 7A-7E illustrate exemplary data structures that can be utilized to implement certain aspects of the present invention.

FIG. 8 illustrates an exemplary graphical user interface that can be utilized in some embodiments of the present invention.

### DESCRIPTION

The present invention provides methods and systems that facilitate the prevention of money laundering by monitoring various facets of a transaction via automated test routines and automatically generating an action to address a high risk transaction based upon the results of the monitoring.

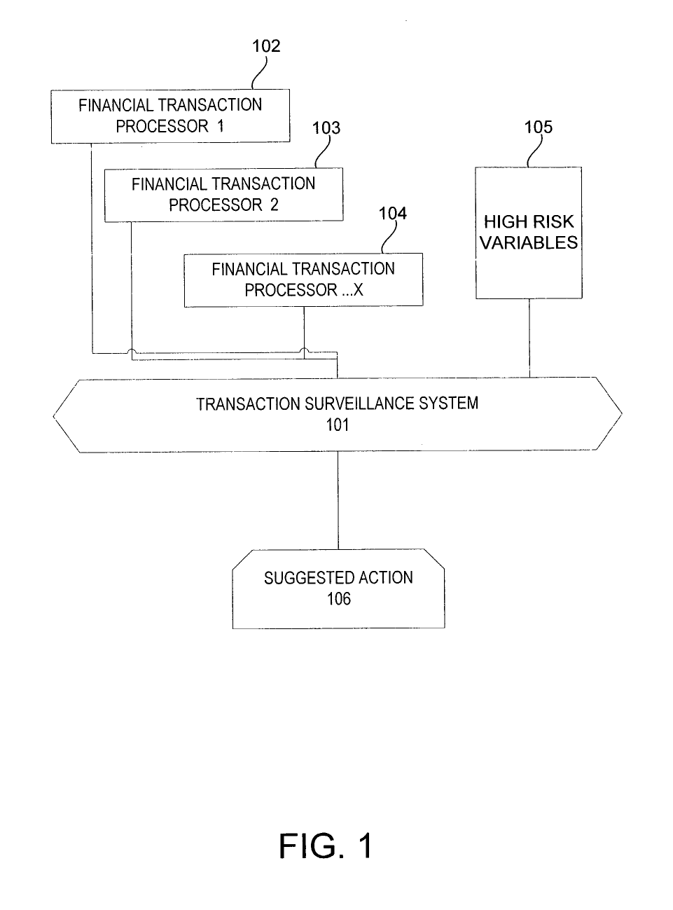

Referring now to FIG. 1, a block diagram illustrates basic components of the present invention. A computerized Transaction Surveillance system 101 is linked to one or more Financial Transaction Processors 102-104 so that it can monitor data descriptive of financial transactions being conducted or contemplated by an organization operating the Financial Transaction Processor 102-104. Monitoring can include receiving and storing the data or a flow of the data though the Transaction Surveillance system 101. Embodiments can therefore include a live shadow stream of actual data traversing a Financial Transaction Processor 102-104 during operation of the Financial Transaction Processor 102-104 or a summarized aggregation of pertinent information.

The Transaction Surveillance system 101 can also be operatively linked to a reference of high risk variables 105 that relate to money laundering or other compliance concerns. A high risk variable 105 can include, for example, a description of a high risk entity or country, account number, organization name, name of an individual suspected or known to be involved with illegal activities, or other datum that can be useful to associate a transaction with money laundering activity or otherwise indicate an elevated reason for concern. The reference of high risk variables 105 can include, for example, a database of names designated by government source or other organization, such as, for example, the Financial Action Task Force (FATF), the Office of Foreign Asset Control (OFAC), Financial Stability Forum (FSF) or other source.

The Transaction Surveillance system 101 compares the data descriptive of financial transactions that is received from the Financial Transaction Processor 102-104 with the high risk variables accessed in the reference for high risk variables 105 and reports on any indications of high risk variables in the data received. Based upon the substance of the report, a suggested action is generated which can provide direction concerning an appropriate action to take in response to the discovery of the indication of money laundering.

Embodiments of the present invention can include a Transaction Surveillance system 101 that is operative within a Financial Institution or a Transaction Surveillance system 101 that is operative amongst multiple Financial Institutions depending upon its implementations. For the sake of simplicity, this document will be directed generally to a system implemented within a firm, however, the basic concepts can be applied on a comprehensive group of Financial Institutions or any subset thereof.

The Transaction Surveillance system 101 can receive data from the Financial Transaction Processor 102-104 to monitor different facets of a transaction including, for example, two main facets that can be monitored include:

i. cash receipts to a Financial Institution such as: third party payments; names of countries, individuals and companies on high risk source 105, such as an OFAC or FATF list; and payments from high risk countries; and

ii. profiling which ascertains inconsistent cash receipts and payments activity at the account-level.

The Transaction Surveillance system 101 can run routines that determine if cash receipts data or other transactional data matches descriptions of high risk variables 105 and/or determines if inconsistencies in data descriptive of an account profile are indicative of money laundering or other suspect practices. If data received from a Financial Transaction Processor 102-104 raises a transaction that fails one or more of the above tests, the transaction can be flagged with a corresponding code and an exception report can be generated indicating the failure. The exception report can be provided to an appropriate person or entity to address a particular situation, such as, for example, a Treasury controls group or a business intelligence group (BIG).

The Treasury controls group, BIG, or other group can review created reports on a periodic basis and take an appropriate action. In some embodiments, a suggested action can also be generated by the Transaction Surveillance system 101 to provide assistance to personnel looking to address the reports. Actions can include, for example, closing an exception report that can be identified as “false positive”,or to re-queue them to the BIG or other appropriate party for further investigation.

A Transaction Surveillance system 101 can generate multiple types of exception reports, such as, for example: transaction level cash receipt checks, including: High Risk Country reports; Third Party Receipts; OFAC list names; and account level cash receipts and payments checks (detection of unusual transactions at the account level) Beta; Delta; and Theta profiling reports.

High Risk Country Monitoring

The High Risk CounTry (HRCT) check can be utilized to draw attention to all receipts with links to any of the countries on the HRCT list. This would usually mean a receipt has come from or through a HRCT.

A HRCT list can be compiled by the BIG, or other group or entity, and be made part of the high risk variable reference 105. It can be compiled, for example, based upon, but not limited by, a combination of the following sources: Financial Stability Forum (FSF) which is a regulation and transparency forum; FATF which is an anti-money laundering group; Organization for Economic Co-operation and Development (OECD) which is working to eliminate harmful tax practices worldwide; or other source. An HRCT exception report can be created by the Transaction Surveillance system 101, for example, when a match meets or exceeds a threshold (such as more than 65%). Match percentages can be set to minimize errors in spelling and grammar affecting the validity of the Transaction Surveillance system 101 hits.

Third Party Receipts

Although a Financial Institution may know the source of its client's wealth through due diligence procedures in the account opening process, if funds are received from a third party, it may not necessarily know the source of their funds. The absence of a world-wide standard for the inter-bank SWIFT message format, irregularities and variations in the formatting amongst agents and correspondent banks make it difficult to ascertain all third party receipts. In some embodiments, the present invention can utilize a uniform SWIFT message format to provide improved data quality.

OFAC List Names

The Office of Foreign Assets Control is a sub-department of the US Department of Treasury, which administers and enforces economic and trade sanctions against targeted foreign countries and individuals, terrorist organizations, Financial Institutions, international narcotic traffickers, revolutionary groups and banned vessels based on US foreign policy and national security goals. a Financial Institution being a US firm must abide by these rules.

In some embodiments it may be important to pay particular attention to OFAC ‘hits’ or other designations by the Transaction Surveillance system 101 that a transaction contains a high risk variable 105 relating to an OFAC sanction or other directive. A transaction that is subject to an OFAC directive that is not ascertained and addressed, may subject a Financial Institution to reputational and regulatory damage. Therefore, some embodiments may provide that if the Transaction Surveillance system 101 detects any level of risk of an OFAC directive associated with a transaction, the Transaction Surveillance system 101 will forward details of the transaction to a designated BIG.

Due to the nature of OFAC, and false positives that can generally be raised, some embodiments can include a set of rules that are developed in conjunction with BIG. In order to prevent ambiguity in OFAC related cases; rules can include variations of the present invention and include a system and method that will:

1) identify patterns of transactions and create exceptions, but not identify the parties involve;

2) track all movement associated with an account holder including identification of parties to a transaction;

3) allow an institution to operate its own surveillance and submit exceptions to a centralized service entity;

4) allow a third party operator to profile and look for exceptions in multiple institutions and pool exceptions for cross analysis. This embodiment can also allow for reporting back to the individual institutions and/or the rating of risk associated with a party or transaction.

Account Profiling

In some embodiments, account profiling or clustering can be used on various divisions, such as the Private Wealth Management Division, to identify unusual or high risk behaviour associated with an account. A statistical method can be utilized to group or cluster similar transactions within an account in order to give a profile of usual behaviour for that account based on historical data. For example, a statistical method can include a method based upon the Euclidean Sum of Squares or any other appropriate statistical method. Embodiments can include, for example, each account having its own profile, account types having a shared profile, or other segregation of accounts to be included in a shared profile.

As it becomes appropriate, some embodiments can allow profiles to be adjusted to reflect new types of activities. For example, as money-laundering cases become known, any display of common characteristics that are indicative of money laundering activity can be addressed by a Transaction Surveillance system 101 profile.

A high risk variable can include a change in an account's usual behaviour indicated, for example, when a transaction falls outside its profile. The Transaction Surveillance system 101 can generate a report to indicate this high risk variable, such as, for example, one or more of the following types of profiling exception reports: Beta, Delta and Theta to report such a high risk variable.

Beta Model

A Beta exception report can be designed to show unusual changes in a rolling balance and indicate whether this change is due to an increase in amount or frequency.

Typical money laundering behavior that a Beta model can be designed to detect can include a pattern of ‘money in, money out’, i.e. using a Financial Institution as a wash account. Variables in a Beta exception report can include, for example: United States Dollar (USD) amount of the transaction; average USD amount of all transactions over the period of last 15 days (USD Balance); frequency count of transactions in the last 15 days; or other account behaviour.

Delta Model

A Delta exception report can be designed to ascertain abnormal increases in the amount and frequency of transactions within an account. Typical money laundering behavior that Delta exception reports can be designed to detect can include sudden changes in amount and frequency of transactions. The presence of high risk variables 105 that can result in a Delta reports can include, for example: a change in a USD Amount of a transaction, frequency of transactions in the last 15 days, or other aberrant behaviour.

Theta Model

High risk variables 105 that a Theta model can detect can include unusual increases in payments and receipts in relation to the balance of the account. Typical money laundering behavior that a Theta exception report can be designed to report can include, for example: stockpiling of cash into or out of an account; variable USD Balance over the last 15 days; debit count over the last 15 days; credit count over the last 15 days; or other unusual payments or receipts. A specific example of a high risk variable 105 that a Theta model may indicate can include, for example, checking for clients continually inputting money into their account and then making one large payment and vice versa.

Reports can be presented to a user in a list, by abstract, complete with all details or other format. Presentation of reports can also include, for example, listings in chronological order. Embodiments can also include highlighting to indicate how recent a report is, such as, for example, most recent exception reports highlighted in green, then yellow, through to the older reports being highlighted in red. Embodiments can also include a suggested action being generated for an exception report with some doubt as to the high risk variable 105 associated with it, indicating that the report should be re-queued to a BIG and annotated accordingly.

As an illustrative example, an incoming SWIFT message from an agent bank may match a high risk variable 105 directed to a HRCT by greater than 65%. The offending match can show in an “External” stop descriptor box with a ‘listed’ country and word match showing in an “Internal” stop descriptor box.

If the hit is a clear and obvious false positive such as, for example, the matching system has taken “George” to read “Georgia”. A synonym can be added. If the stop descriptor has pulled up a valid HRCT hit, or a user, such as an analyst, is in any doubt, then the case can be requeued to the BIG.

Following the identification and classification of a case, an action can be implemented so that the responsibility for the case can be passed to an appropriate area or closed down, either as a one off or for all similar cases going forward.

If a case is to be assigned, the case can be entered into an assigned queue tagged to a user ID. A synonym can be added by using a False Positive button, which can prevent cases of this nature being marked for user attention again by annotating the error with a relevant description from the drop down box, and keeping a record of a stop descriptor encountered. Some embodiments can include a list of cases that will be affected by the addition of a synonym.

A case can also be Re-Queued to a necessary department, such as BIG. Once a case has been re-queued to the necessary department, the department can view these items. At this point a department to which this case is queued can also take responsibility for investigating and resolving the case.

A case may be closed using a close case icon. Some embodiments can limit this action so that it is only done where there is no likelihood of a similar case being seen again, or where there are so many stop descriptors that is not feasible to add a synonym for each one.

Methods

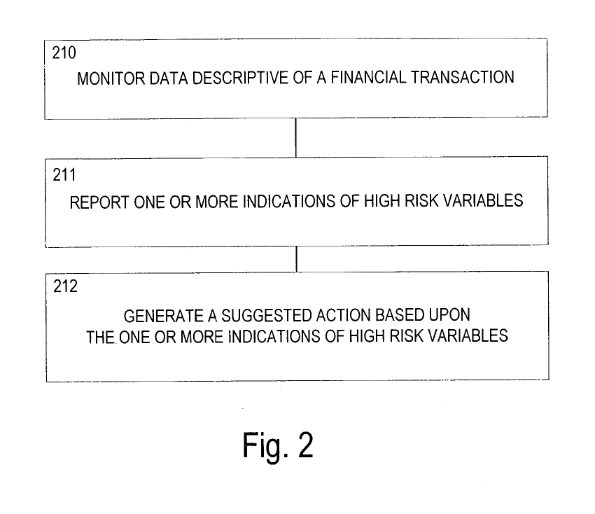

Referring now to FIG. 2, a method that can be utilized by a Transaction Surveillance system 101 in some embodiments of the present invention is illustrated. At 210, the Transaction Surveillance system 101 can monitor data descriptive of one or more financial transactions.

The Transaction Surveillance system 101 system can be fed data to monitor directly from an Account Master (static data), Treasury Reconciliation's system (T-Recs) database, e Transaction Hub (T-Hub) or other appropriate source. A main source of data descriptive of financial transactions can include a transaction protocol provider, such as SWIFT advice messages received from agent banks.

At 211, a report can be made indicating one or more high risk variables being associated with a transaction. For example, a reported indication may include information contained in a SWIFT message that corresponds with a high risk variable 105 and/or information lacking in a SWIFT message that corresponds with high risk variable 105. The indication may include, for example, the name of a high risk person, involvement of a high risk country, a profile of a high risk transaction, a pattern of transactions indicating high risk, or other indication.

At 212, the Transaction Surveillance system 101 can generate a suggested action based upon or otherwise responsive to the report of a high risk variable. The suggested action can include, for example, an action that has been predetermined to be appropriate in a set of circumstances similar to those represented by the report. For example, in response to a report, further investigation may be suggested on the part of a Treasury department in order to close a case as a False Positive, or to re-queue the case to the Business Intelligence Group (BIG).

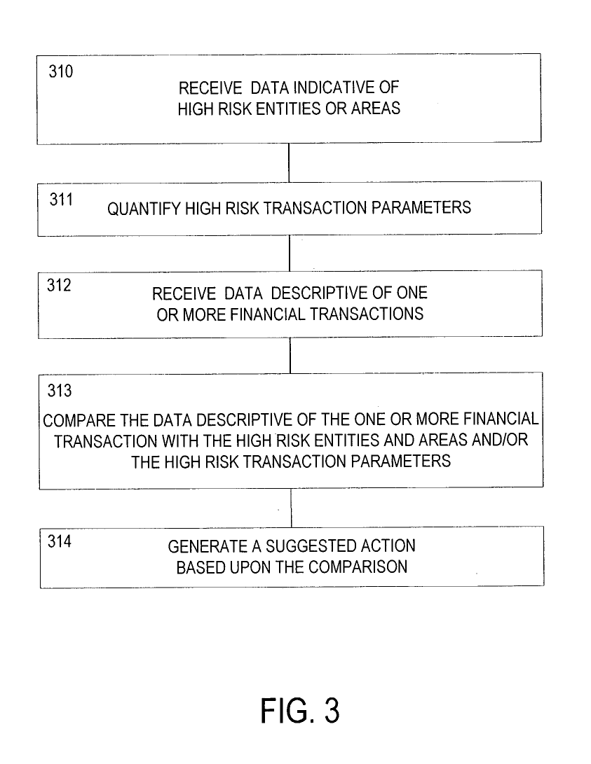

Referring now to FIG. 3, additional steps that can be performed in some implementations of the present invention are illustrated. At 310, the Transaction Surveillance system 101 can receive data indicative of a high risk entity or area. The data can be received from a government agency or other source such as those discussed in more detail above. An entity can include, for example, a person or organization. A high risk area can include, for example, a country, jurisdiction, or other physical designation.

At 311 the Transaction Surveillance system 101 can quantify, or otherwise identify, one or more high risk parameters that can be associated with a transaction. Parameters can include, for example, transaction patterns, relative amounts, clustering or other means of determining high risk activity.

At 312, the Transaction Surveillance system 101 can receive data descriptive of one or more financial transactions and at 313 compare the data descriptive of he financial transaction with the data indicative of high risk entities or areas and/or the high risk transaction parameters. At 314 the Transaction Surveillance system 101 can generate a suggested action based upon the comparison of 313. A suggested action can be any action, which had been determined to be appropriate for a circumstance involving risk variables 105 associated with the results of the comparison of 313. A suggested action can therefore include designating an appropriate person or group to conduct a further review, blocking a transaction, closing an inquiry, or other action.

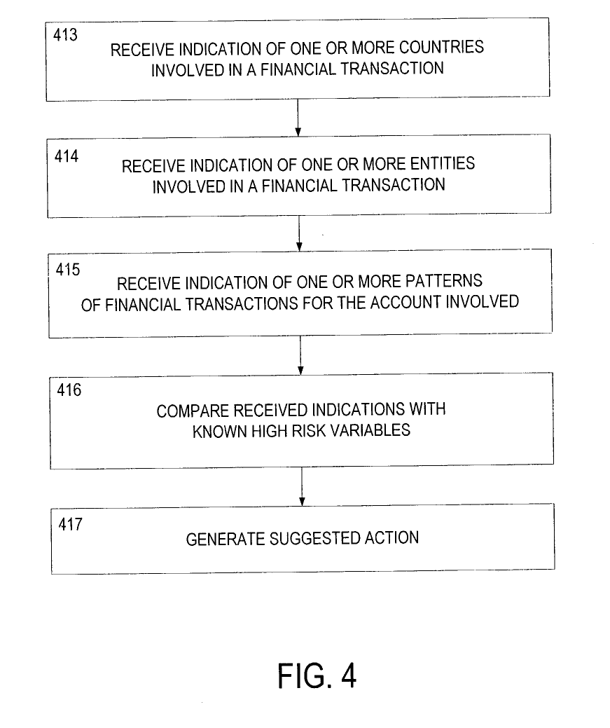

Referring now to FIG. 4, steps that can be completed in implementing a variation of the present invention are illustrated. At 413, an indication of one or more countries involved in a transaction can be received. At 414, an indication of one or more entities involved in the financial transaction can be received, and at 415, an indication of one or more patterns of financial transactions involving a related financial account can be received.

At 416, known high risk variables 105 can be compared to the indications received, so that at 417 a suggested action can be generated based upon the comparison of the known high risk variables 105 and the indications received.

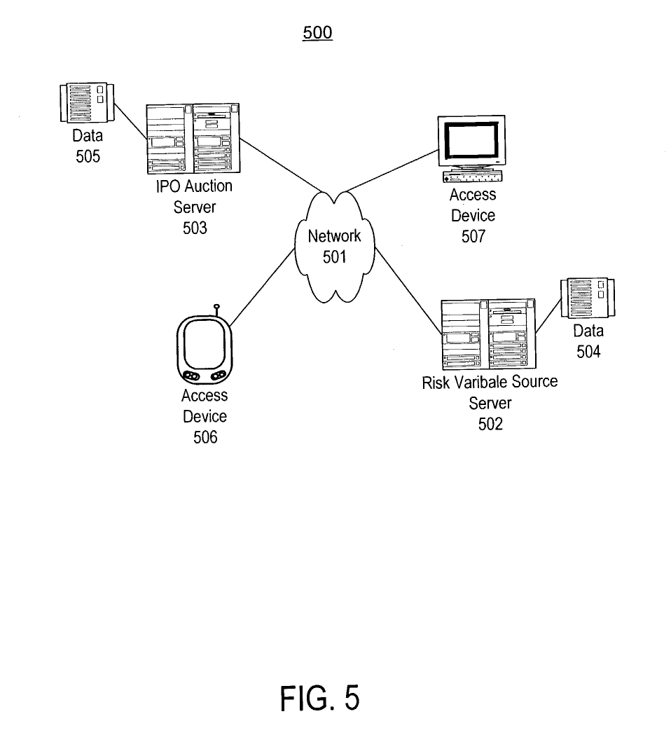

Referring now to FIG. 5, a network diagram illustrating one embodiment of the present invention is shown 500. An automated Transaction Surveillance system 101 can include a computerized controller 503 accessible via a distributed network 501 such as the Internet, or a private network. An automated Transaction Surveillance system 101 can be operatively connected to a computerized Transaction Surveillance controller 503 accessible via the distributed network 501. A user can use a computerized system or network access device 506-507 to receive, input, transmit or view information processed in the Transaction Surveillance controller 503, Risk Variable Source controller 502, a peer device, or other network access device 506-507. A protocol, such as, for example, the transmission control protocol internet protocol (TCP/IP) can be utilized to provide consistency and reliability.

A system access device 506-507 can communicate with the Transaction Surveillance controller 503 or Risk Variable Source controller 502 to access data and programs stored at the respective servers. A system access device 506-507 may interact with the Transaction Surveillance controller 503 or Risk Variable Source controller 502 as if the servers were a single entity in the network 500. However, the Transaction Surveillance controller 503 and Risk Variable Source controller 502 may include multiple processing and database sub-systems, such as cooperative or redundant processing and/or database servers that can be geographically dispersed throughout the network 500.

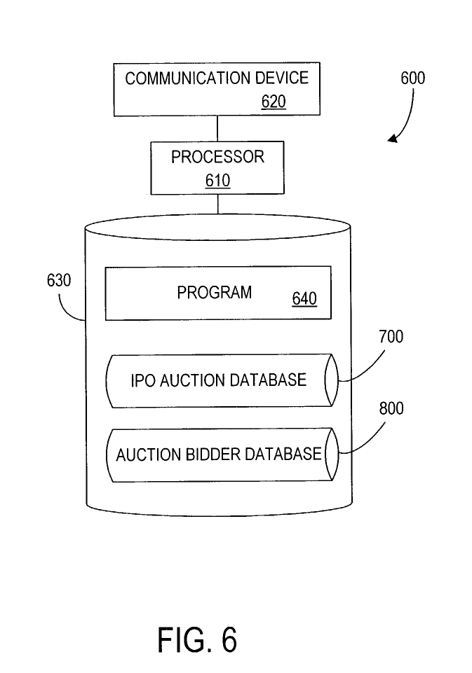

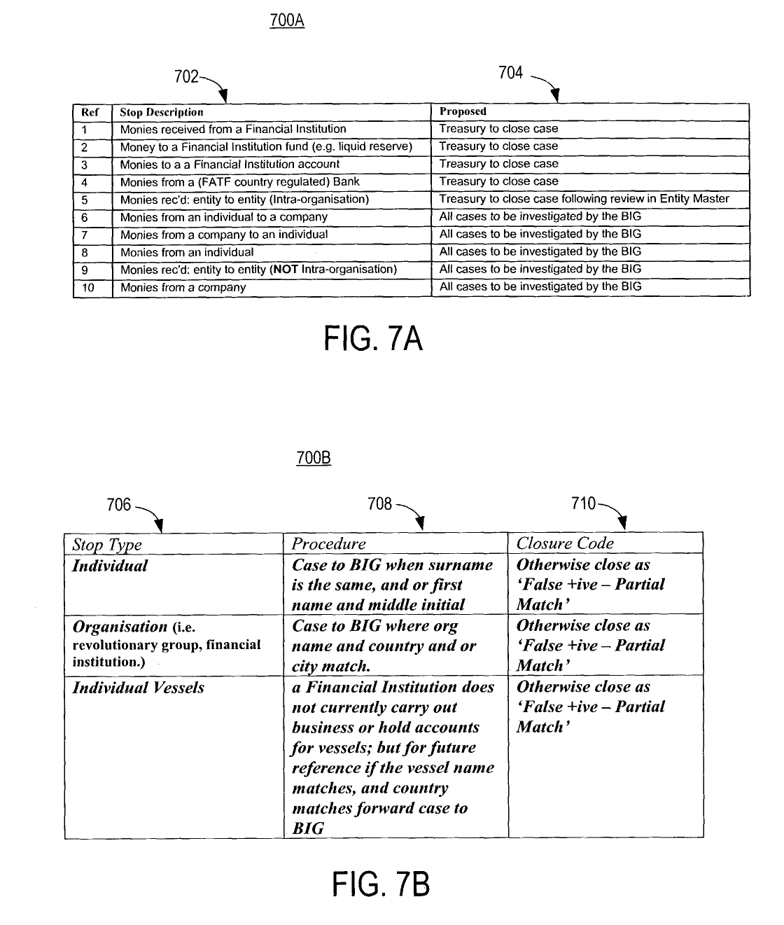

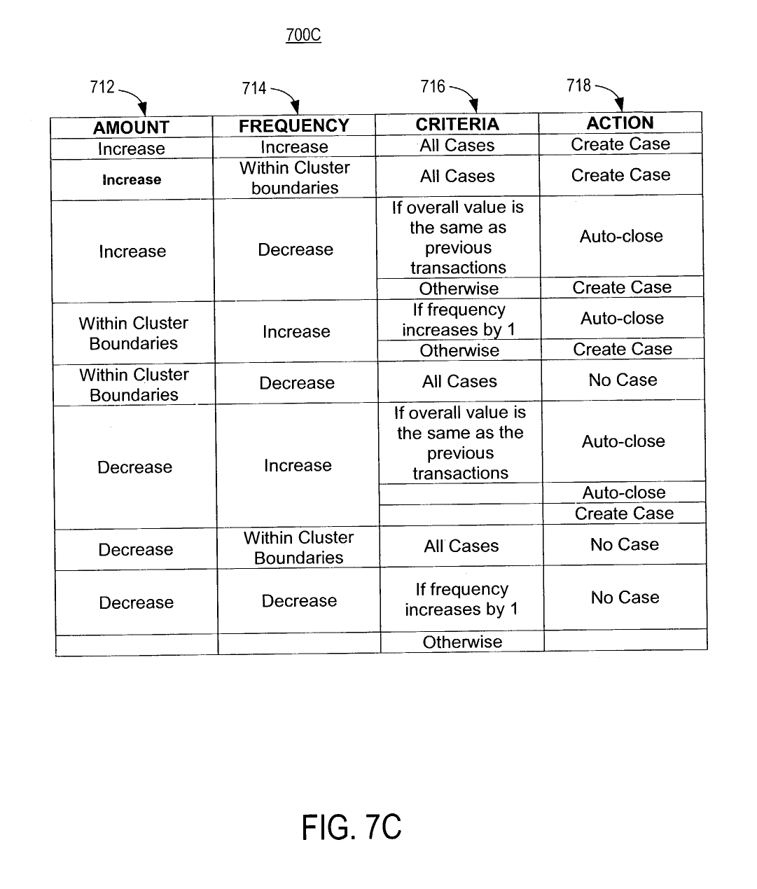

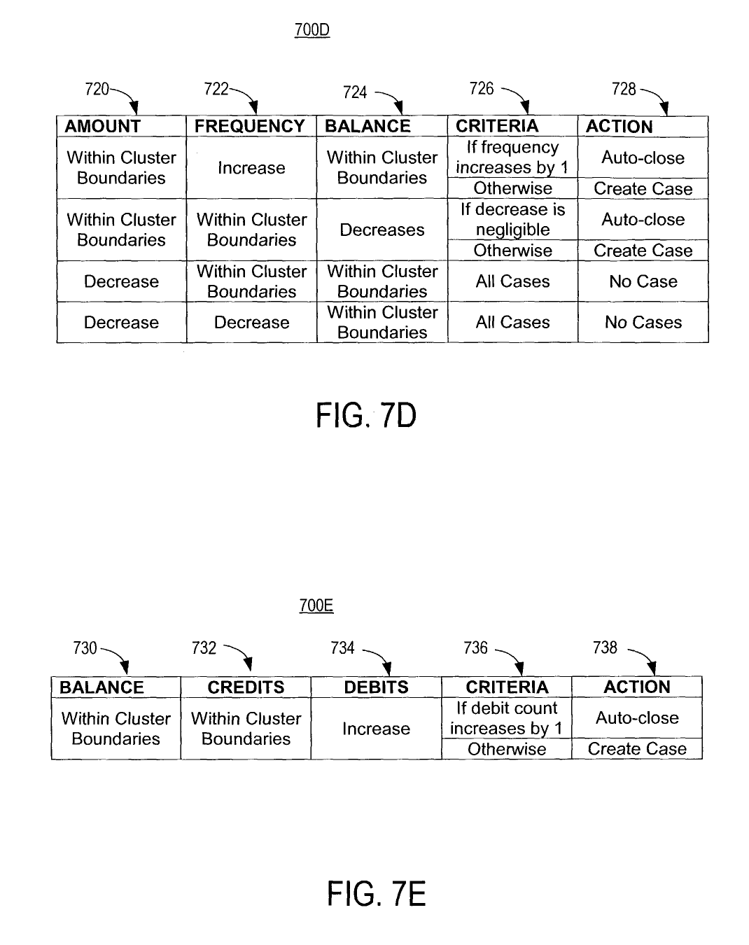

A server utilized as a Risk Variable Source controller 502 and Transaction Surveillance controller 503 can include a processor, memory and a user input device, such as a keyboard and/or mouse, and a user output device, such as a display screen and/or printer, as further detailed in FIG. 6. The server can also include one or more data storage devices 504-505 storing data relating to a Transaction Surveillance system 101. Exemplary data structures are also desribed in more detail below in FIGS. 7A-7E. Information relating to and used in conjunction with a Transaction Surveillance operation can be aggregated into a searchable data storage structure. Gathering data into an aggregate data structure 504-505, such as a data warehouse, allows a server to have the data readily available for processing Transaction Surveillance related routines. Aggregated data 504-505 can also be scrubbed or otherwise enhanced to aid in searching.

Typically, an access device 506-507 will access an Transaction Surveillance system using client software executed at the system access device 506-507. The client software may include a generic hypertext markup language (HTML) browser, such as Microsoft Internet Explorer, (a “WEB browser”). The client software may also be a proprietary browser, and/or other host access software. In some cases, an executable program, such as a Java™ program, may be downloaded from a server to the system access device 506-507 and executed at the system access device 506-507 as part of a Transaction Surveillance system 101. Other implementations include proprietary software installed from a computer readable medium, such as a CD ROM. The invention may therefore be implemented in digital electronic circuitry, computer hardware, firmware, software, or in combinations of the above. Apparatus of the invention may therefore include a computer program product tangibly embodied in a machine-readable storage device for execution by a programmable processor; and method steps of the invention may be performed by a programmable processor executing a program of instructions to perform functions of the invention by operating on input data and generating output.

FIG. 6 illustrates a controller 600 that can be included in a server or access device shown, for example, in FIG. 5, according to some embodiments of the present invention. The Transaction Surveillance controller 600 comprises a processor 610, such as one or more processors, coupled to a communication device 620 configured to communicate via a communication network (not shown in FIG. 6). The communication device 620 may be used to communicate, for example, with one or more network access devices 506-507.

The processor 610 is also in communication with a storage device 630. The storage device 630 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 630 can store a program 640 for controlling the processor 610. The processor 610 performs instructions of the program 640, and thereby operates in accordance with the present invention. For example, the processor 610 may receive information descriptive of a Transaction Surveillance including auction and pre-auction details and allocate shares according to rules defined by the details. The processor 610 may also transmit information comprising share allocation, pricing, or other information. The storage device 630 can store Transaction Surveillance related data in one or more databases. The illustration and accompanying description of the transaction surveillance related database presented herein is exemplary, and any number of other database arrangements can be employed besides those suggested by the figures.

Data Structures

Referring now to FIG. 7A-7E, exemplary designs of various portions of one or more data structures 700A-700D that can be utilized while implementing the present invention are illustrated. Such illustrations are exemplary and enabling but are not meant to be comprehensive or limiting. Other datum may also be stored and accessed. In addition, the data can be arranged and accessed using any known data storage and accessing techniques.

Referring now to FIG. 7A, a data structure 700A utilized in implementations can include a portion, such as a data field, containing data descriptive of a stop description 702 including one or more values for a risk variable 105 comprising a list of exceptions for third party receipts. The data structure 700A can also include a portion containing a suggested or proposed course of action 704 based upon the stop description 702.

The data structure of FIG. 7A can be generated, for example, by a Transaction Surveillance system 101 which can place the name of a client account in an Internal Stop Descriptor box or data field. The name of the Ordering institution can be ascertained from the appropriate field of an associated SWIFT message and copied to the External Stop Descriptor field. If these two fields have a threshold match that is less than user definable threshold match (such as 65%), the payment can be deemed a third-party receipt and a case will be created.

The examples illustrated in FIG. 7A include exemplary data descriptive of various facts relating to a financial transaction 702 and corresponding actions that can be generated based upon the data descriptive of the financial transaction 702, as follows:

1. Monies received from a Financial Institution. This case type should be closed as “VALID RECEIPT FROM a Financial Institution”. If only one of these fields match, the receipt should be further investigated.

2. Monies received to a Financial Institution fund account. Check client account details on case form and close as “VALID RECEIPT FROM a Financial Institution” (eg. a Financial Institution Liquid Reserve).

3. Monies to a Financial Institution account. Check client account details on case form and close as “External Receipt to a Financial Institution Account”.

4. Monies received from a FATF country regulated Financial Institution. Treasury to close case as “False Positive—On Approved List”.

5. Monies received as a result of an intra-organization transaction, entity to entity. Check Entity Master for connection, close as “Entity to Entity”.

6. Monies received from an individual to a company, wherein case is a valid 3^{rd} party, re-queue to BIG. These are the kind of cases that can result in a potential risk to a Financial Institution.

7. Monies received from a company to an individual, where case is a valid 3^{rd} party. Re-queue to BIG, these are the kind of cases that can prove a potential risk to a Financial Institution.

8. Monies received from an individual, where case is a valid 3^{rd} party. Re-queue to BIG.

9. Monies received from an entity to entity, in a transaction that is not intra-organizational and case is a valid 3^{rd} party. Re-queue to BIG, these are the kind of cases can prove a potential risk to a Financial Institution.

10. Monies from a company, where the transaction involves a valid 3^{rd} party. Re-queue to BIG.

FIG. 7B illustrates another data structure, which also includes a stop type 706 and corresponding procedure 708 or suggested action, as well as a closure code 710. The closure code-includes a code that can be utilized to record a resolution to a stop 706.

Referring now to FIGS. 7C-7D, data structures exemplifying data that can be associated with Delta, Beta, and Theta account profiling are illustrated. In FIG. 7C, exemplary data associated with Delta profiling is illustrated, including data indicative of an amount 712, a frequency 714, criteria 716 and a suggested action 718. FIG. 7D includes exemplary data 700D associated with Beta profiling, including: an amount 720, a frequency 722, a balance 724, a criteria 726 and an action 728. FIG. 7E illustrates exemplary data 700E associated with Theta profiling, including, a balance 730, credits 732, debits 734, criteria 736 and an action 738.

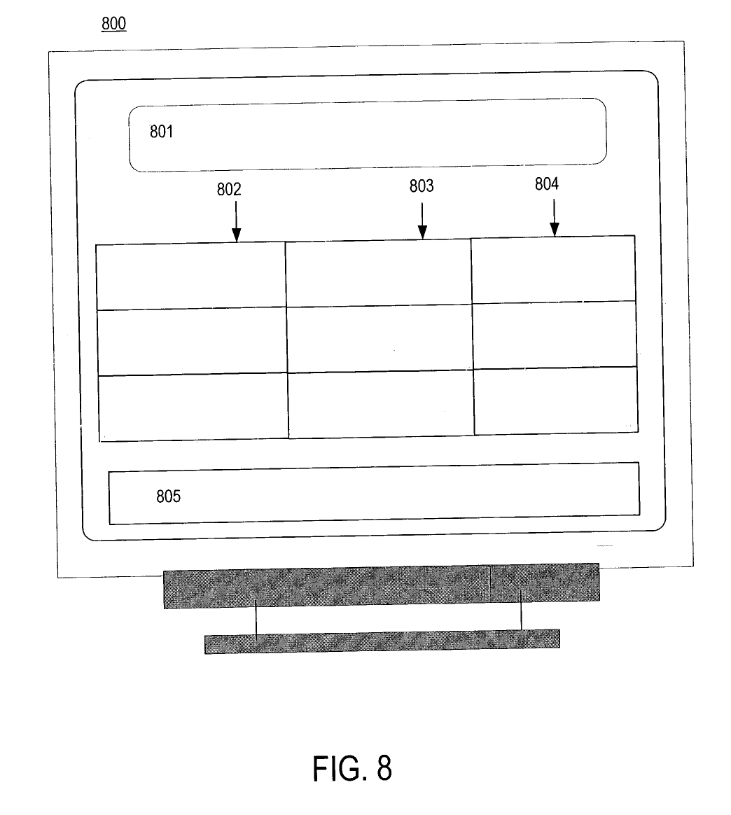

Referring now to FIG. 8, an exemplary GUI 800 that can be utilized while practicing the present invention is illustrated. The GUI can be presented on a network access device 506-507 or any other type of terminal or interactive station capable of creating a display pursuant to an electronic signal. A portion of display 801 can display information descriptive of transaction, such as for example, a type of transaction, amounts involved, account profile, countries involved and parties involved. Another portion of the display 802 can include information descriptive associated risk variables. Still another portion 803 can contain information descriptive of a suggested action or procedure to based upon the transaction information and the risk variable information. If appropriate, a criteria can also be displayed in another portion 803, and an additional portion can include a closure code or process 805.

A number of embodiments of the present invention have been described. Nevertheless, it will be understood that various modifications may be made without departing from the spirit and scope of the invention. Accordingly, other embodiments are within the scope of the following claims.

What is claimed is:

1. A method for managing risk associated with one or more financial transactions, the method comprising:
compiling a reference of high risk variables;
monitoring data descriptive of a financial transaction for one or more indications of high risk variables according to predetermined criteria;
reporting one or more indications of high risk variables; and
generating a suggested action based upon the report of one or more indications of high risk variables.

2. The method of claim 1 wherein the monitoring comprises determining if a data value is within a cluster boundary.

3. The method of claim 1 wherein the monitoring comprises determining if a data value comprising a transaction frequency is within a threshold delta from a previously existing data set.

4. The method of claim 1 wherein the monitoring comprises determining if a data value comprising a currency amount is within a threshold delta from a previously existing data set.

5. The method of claim 1 wherein the monitoring comprises identifying a pattern relating to financial transactions and determining exceptions to the pattern.

6. The method of claim 6 wherein the pattern is identified from data descriptive of a specific account.

7. The method of claim 6 wherein the pattern is identified from data descriptive of a specific account type.

8. The method of claim 6 wherein the pattern is identified from data descriptive of transactions originating in a particular country.

9. The method of claim 1 wherein the data descriptive of a financial transaction comprises data descriptive of a cash receipt.

10. The method of claim 9 wherein the cash receipt comprises a third party payment.

11. The method of claim 9 additionally comprising the step of identifying one or more high risk countries and the cash receipt comprises a country identified as a high risk country.

12. The method of claim 1 wherein the data descriptive of a financial transaction comprises data descriptive of a third party receipts check.

13. The method of claim 1 wherein the data descriptive of a financial transaction comprises data descriptive of an Office of Foreign Asset Control receipts check.

14. The method of claim 1 additionally comprising the step of identifying one or more high risk countries and the data descriptive of a financial transaction comprises a high risk country receipt check.

15. The method of claim 1 wherein the monitoring comprises account profiling comprising at least one of: determining a change in a transaction amount; determining a change in transaction frequency; and determining a value for a criteria.

16. The method of claim 15 wherein monitoring determines an increase in transaction amount, an increase in transaction frequency and the suggested action comprises creating an investigation case.

17. The method of claim 15 wherein monitoring determines an increase in transaction amount; a transaction frequency within a cluster boundary and the suggested action comprises creating an investigation case.

18. The method of claim 15 wherein monitoring determines an increase in transaction amount, an increase in transaction frequency and the suggested action comprises creating an investigation case.

19. The method of claim 15 wherein monitoring determines an increase in transaction amount, a decrease in transaction frequency, the overall value of transactions considered is within a predetermined delta as transactions during a previous time period and the suggested action comprises automatically closing the monitoring.

20. The method of claim 15 wherein monitoring determines an increase in transaction amount, a decrease in transaction frequency, the overall value of transactions considered is not within a predetermined delta as transactions during a previous time period and the suggested action comprises creating an investigation case.

21. The method of claim 15 wherein monitoring determines a balance within a cluster boundary, a credit value within a cluster boundary, an increase in debits during a time period and the suggested action comprises creating an investigation case

22. A method for managing risk associated with a financial transaction, the method comprising:
receiving an indication of one or more countries involved in a financial transaction;
receiving an indication of one or more entities involved in a financial transaction;
receiving an indication of one or more transaction patterns;
comparing the received indications with known risk variables; and
generating a suggested action based upon the comparison.

23. A computerized system for managing risk associated with one or more financial transactions, the system comprising:
a computer server accessible with a system access device via a communications network; and
executable software stored on the server and executable on demand, the software operative with the server to cause the server to:
monitor data descriptive of a financial transaction for one or more indications of a high risk variable according to predetermined criteria;
report one or more indications of a high risk variable; and
generating a suggested action based upon the one or more indications of a high risk variable.

24. Computer executable program code residing on a computer-readable medium, the program code comprising instructions for causing the computer to:
monitor data descriptive of a financial transaction for one or more indications of a high risk variable according to predetermined criteria;
report one or more indications of a high risk variable; and
generating a suggested action based upon the one or more indications of a high risk variable.

25. A computer data signal embodied in a digital data stream comprising data relating to a financial transaction, wherein the computer data signal is generated by a method comprising the steps of:
monitoring data descriptive of a financial transaction for one or more indications of a high risk variable according to predetermined criteria;
reporting one or more indications of a high risk variable; and
generating a suggested action based upon the one or more indications of a high risk variable.

26. A system for managing risk associated with a financial transaction, the system comprising:
one or more financial transaction processing units generating data descriptive of one or more financial transactions;
a data compilation comprising high risk variables for a financial transaction; and
a computerized transaction surveillance server operatively connected to the one or more financial transaction processing units to access the data descriptive of one or more financial transactions and also connected to the data compilation, wherein the computerized transaction surveillance server can automatically monitor the data descriptive of one or more financial transactions and indicate if the data correlates with a high risk variable.
